(19) United States
(12) Patent Application Publication
(10) Pub. No.: US 2013/0322707 A1
(43) Pub. Date: Dec. 5, 2013

(54) PRODUCING PERSONALIZED TEAM PHOTO BOOKS

(71) Applicants: JONATHAN BLAIR PHILLIPS, Rochester, NY (US); Kenneth Alan Parulski, Rochester, NY (US); Brian Joseph O'Keefe, Rochester, NY (US)

(72) Inventors: JONATHAN BLAIR PHILLIPS, Rochester, NY (US); Kenneth Alan Parulski, Rochester, NY (US); Brian Joseph O'Keefe, Rochester, NY (US)

(21) Appl. No.: 13/488,472

(22) Filed: Jun. 5, 2012

(51) Int. Cl. G06K 9/62

(52) U.S. Cl. 382/118

(57) ABSTRACT

A method for use in producing a plurality of personalized photo books for members of a team, including storing a plurality of images including at least one group image of the team members and images including individual team members participating in different events, and using a processor to automatically recognize the team members in the plurality of stored images and select a subset of the plurality of stored images for particular members of the team including images associated with at least two different events.

### FIELD OF THE INVENTION

The present invention relates to producing photo books and more particularly to producing personalized photo books for members of a team which includes images associated with team events.

### BACKGROUND

It is known to produce photo books using various on-line services for various events, such as weddings, vacations, and graduations. For example, the Kodak Gallery website enables customers to upload images and create photo books and photo albums using the uploaded images. The Kodak Gallery website can automatically arrange uploaded images on pages of the photo book, and then permit the user to move their photos around and add text messages. The photo books are then printed and shipped to the customer, or to a recipient chosen by the customer.

It is also known to use walk-up photo kiosks in retail establishments to produce photo books. For example, Kodak Picture Maker Kiosks enable a user to create photo books using scanned prints, digital images read from a memory card or CD, and digital images available from on-line photo sites such as Facebook and the Kodak Gallery. The customer can arrange images from these sources as pages of the photo book, which can be printed at the retail establishment.

It is also known to provide systems which produce a large number of identical photo books for school classes or teams. However, these photo books are not customized for the individuals on the team, so they are not necessarily cherished by the team members. For example, the book can include a large number of images, but only a few of these images will typically include the particular team member.

It is also known to provide systems which enable professional photographers to produce photos of class members or team members. Each member is photographed by the professional photographer, and a collection of prints can be purchased, typically by the member's parents. In some cases, a group photograph of the team or class is also captured by the professional photographer. In some of these cases, one of the prints in the collection of prints includes both the team image and an image of a particular team member, along with text identifying the team name and year.

It is known to provide websites which permit a group of people to create a photo book together. For example, the mixbook website permits a user to invite friends and family to join them in creating a photo book. Everyone can upload their photos to the same project, and then personalize and decorate their pages together. Also, U.S. Pat. No. 7,506,246 “Printing a custom online book and creating groups of annotations made by various users using annotation identifiers before the printing” describes a system for creating a photo book having pictures and annotations made by various users.

It is also known to automatically create a photo book. For example, US patent publication 2010/0241945 “Proactive creation of photobooks” describes a method of automatically creating a photo book from a group of images. Also, US patent application 2008/0080774 “System and method for collaborative image selection” describes a system which rates images based on user activity and uses the ratings to assemble a set of images for a photo book. However, the system does not automatically produce a plurality of individually personalized photo products.

It is known to use subject identification and event identification as ways of organizing images in a photo album. For example, U.S. Pat. No. 7,362,919 “Method for generating and customizing photo album page and prints based on people and gender profiles” uses subject identification as one technique for organizing image into pages in an album.

It is known that kiosks can use subject identification to retrieve images of a particular user from a large collection of images. For example, a press release entitled “ImageWare Systems and Carnival Cruise Lines Expand Biometric Photo-Finding Kiosk Project” issued on Oct. 13, 2004 describes a system “where a cruise line guest simply steps up to a stand-alone photo-retrieval kiosk which will capture an image of his or her face. This image is compared, using facial recognition technology, to all faces within all photos that have been captured on the cruise. Once the search is complete, photos containing the guest, including group and individual shots, will appear on the screen and be available for review and purchase.”

Another example is provided by the company Youfinder that provides a system where Kiosks can show guests all of their images, rather than in the past, where only portraits that had been manually associated with an identity card can be shown. Guests can see not only their own images on the kiosk, but also images of the friends or family that accompany them. It is now much easier to arrange package sales, as guests see all of their photos in one location, rather than scattered throughout the gallery, and you can now organize post-cruise sales, with all of the photos organized by guest and cabin. A related system is described in US Patent Application 2008/0310688 “Automated Indexing for Distributing Event Photography” which describes a system which uses automated facial recognition to determine which people are in each image. The images indexed in this fashion can be presented in a gallery, ordered by characteristics of the people in the images such as their name or room number, so as to facilitate the selection of the images by the people. The closeness of the relationships of two people can be inferred from the degree to which the people are in the same images, permitting the people in the images to be placed into groups, which can be hierarchical or overlapping, and which can assist in the organization of images presented to the people, either in a gallery or electronic display format.

However, none of these prior art systems or patents can be effectively used to automatically produce personalized team photo books. There is a need therefore, for a system which enables personalized team photo books to be created in an easy and efficient manner.

### SUMMARY OF THE INVENTION

In accordance with the present invention, there is provided a method for use in producing a plurality of personalized photo books for members of a team, comprising storing a plurality of images including at least one group image of the team members and images including individual team members and two or more team members participating in different events, using a processor to automatically recognize the team members in the plurality of stored images; and select a subset of the plurality of stored images for particular members of the team including images associated with at least two different events producing a plurality of proposed photo book layouts personalized for each of a plurality of team members and further including in the layout the at least one group image of the team members and other images depicting the team member in at least two different events, wherein the layout is organized to differentiate between the at least two different events, providing to two or more users for use on a display, a user interface that enables each user to review a particular personalized proposed photo book, and select modifications to the proposed photo book and producing the plurality of personalized photo books responsive to the modifications selected by each of the two or more users.

An important advantage of the present invention is that customized photo books are produced for each team member. Another important advantage is that the customized photo books include images from different team events. Yet another important advantage is that a plurality of different photo books can be provided using a common template each of which feature images of a particular team member.

These, and other aspects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. For example, the summary descriptions above are not meant to describe individual separate embodiments whose elements are not interchangeable. In fact, many of the elements described as related to a particular embodiment can be used together with and interchanged with, elements of other described embodiments. Many changes and modifications can be made within the scope of the present invention without departing from the spirit thereof, and the invention includes all such modifications. The figures below are not intended to be drawn to any precise scale with respect to relative size, angular relationship, or relative position or to any combinational relationship with respect to interchangeability, substitution, or representation of an actual implementation.

### BRIEF DESCRIPTION OF THE DRAWINGS

The above and other features, and advantages of the present invention will become more apparent when taken in conjunction with the following description and drawings wherein identical reference numerals have been used, where possible, to designate identical features that are common to the figures, and wherein:

FIG. 1 depicts a high-level diagram of a system for producing personalized team photo books;

FIG. 2 illustrates one embodiment of an electronic system that can be used for producing personalized team photo books;

FIG. 3 illustrates another embodiment of an electronic system that can be used for producing personalized team photo books;

FIG. 4 depicts a high-level flow chart used by the processer in FIG. 1 for producing personalized team photo books;

FIG. 5 depicts a more detailed flow chart of step 405 in FIG. 4 depicting the automatic recognition of team members;

FIG. 6 depicts a more detailed flow chart of step 415 in FIG. 4 depicting the process of producing proposed layouts;

FIG. 7A depicts a first personalized photo book for a first team member;

FIG. 7B depicts a second personalized photo book for a second team member;

FIG. 8 depicts a user interface for enabling users to review proposed photo books; and

FIG. 9 depicts a number of different styles and sizes of photo books that can be selected by a user using the user interface.

### DETAILED DESCRIPTION OF THE INVENTION

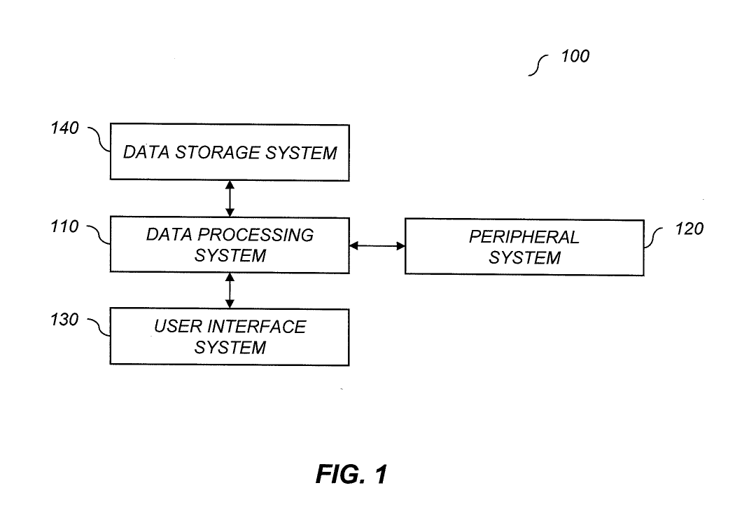

FIG. 1 is a high-level diagram showing the components of a system 100 useful for various embodiments of the present invention. The system 100 includes a data processing system 110, a peripheral system 120, a user interface system 130, and a data storage system 140. The peripheral system 120, the user interface system 130 and the data storage system 140 are communicatively connected to the data processing system 110. The system 100 can be interconnected to other data processing or storage systems through a network, for example the Internet. In some embodiments, a plurality of different users can use remote devices in order to access the system 100.

The data processing system 110 includes one or more data processing devices (or “processors”) that implement the processes of the various preferred embodiments of the present invention, including the example processes described herein. The term “processor” is intended to include any data processing device, such as a central processing unit (“CPU”), a desktop computer, a laptop computer, a mainframe computer, a personal digital assistant, a digital camera, a digital picture frame, cellular phone, a smart phone, a video game console, a cable set-top box, or any other device for processing data, managing data, communicating data, or handling data, whether implemented with electrical, magnetic, optical, biological components, or otherwise.

The data storage system 140 includes one or more processor-accessible memories configured to store information, including a plurality of images which will be used to produce a plurality of personalized photo books. In some embodiments, the processor-accessible memories also store information needed to execute the processes of the various preferred embodiments of the present invention, including the example processes described herein. The data storage system 140 can be a distributed processor-accessible memory system including multiple processor-accessible memories communicatively connected to the data processing system 110 via a plurality of computers or devices. On the other hand, the data storage system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, caches, floppy disks, hard disks, Compact Discs, DVDs, flash memories, ROMs, and RAMs.

The phrase “communicatively connected” is intended to include any type of connection, whether wired or wireless, between devices, data processors, or programs in which data is communicated. The phrase “communicatively connected” is intended to include a connection between devices or programs within a single data processor, a connection between devices or programs located in different data processors, and a connection between devices not located in data processors at all. In this regard, although the data storage system 140 is shown separately from the data processing system 110, one skilled in the art will appreciate that the data storage system 140 can be stored completely or partially within the data processing system 110. Further in this regard, although the peripheral system 120 and the user interface system 130 are shown separately from the data processing system 110, one skilled in the art will appreciate that one or both of such systems can be included within the same device such as the devices listed earlier with respect to the data processing system 110.

The peripheral system 120 can include one or more devices configured to provide digital images to the data processing system 110. For example, the peripheral system 120 can include digital still cameras, digital video cameras, cellular phones, smart phones, or other image capture devices. The data processing system 110, upon receipt of digital images from a device in the peripheral system 120, can store such digital images in the data storage system 140.

The user interface system 130 can include a display, a mouse, a keyboard, a touchscreen, various dedicated buttons, or a voice recognition system, in order to permit a user to provide responses to the system 100. It will be understood that the user interface system 130 used by a particular user can be provided using a single device or by instead using a combination of devices. It will be further understood that the user interface system 130 can be provided in a separate device or included in a device which also includes one or more of the peripheral system 120, the data processing system 110 or the data storage system 140.

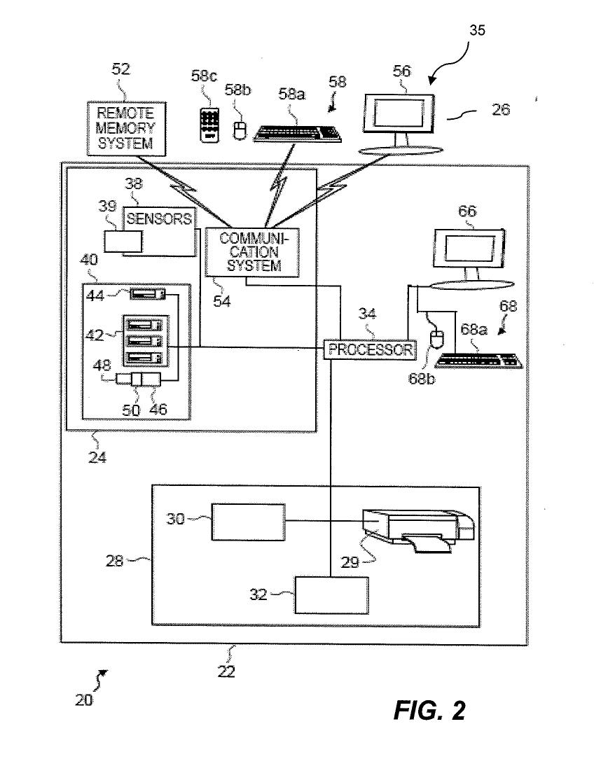

FIG. 2 illustrates one embodiment of an electronic system that can be used for producing personalized team photo books. In the embodiment of FIG. 2, electronic system 20 includes a housing 22 and a source of digital images 24, a user input system 26 and an output system 28 connected to a processor 34. The source of digital images 24, user-input system 26 or output system 28 and processor 34 can be located within housing 22 as illustrated. In other preferred embodiments, circuits and systems which provide the source of digital images 24, user input system 26 or output system 28 can be located in whole or in part outside of housing 22.

The source of digital images 24 can include any form of electronic or other circuit or system that can supply digital data to processor 34 from which processor 34 can derive digital images for use in creating a photo book. In this regard, the images can include, for example and without limitation, still photographic images, still images derived from still image video sequences, graphics, and computer-generated images. In some embodiments, the source of digital images 24 includes one or more sensors 38, such as video camera 39, which capture images to create some of the digital images used in the photo books. In some embodiments, the source of digital images 24 includes a memory section 40 and a communication system 54.

Memory section 40 can include conventional memory devices including solid-state, magnetic, optical or other data-storage devices. Memory section 40 can be fixed within electronic system 20 or it can be removable. In the embodiment of FIG. 2, electronic system 20 is shown having a hard drive 42, a disk drive 44 for a removable disk such as an optical, magnetic or other disk memory (not shown) and a memory card slot 46 that holds a removable memory 48 such as, a removable memory card, and has a removable memory interface 50 for communicating with removable memory 48. Data including, but not limited to, control programs, digital images and metadata can also be stored in a remote memory system 52 such as a personal computer, computer network or other digital system. Remote memory system 52 can also include solid-state, magnetic, optical or other data-storage devices.

In the embodiment shown in FIG. 2, electronic system 20 has a communication system 54 that can be used to communicate with an optional remote memory system 52, an optional remote display 56, or optional remote input 58. The optional remote memory system 52, optional remote display 56, optional remote keyboard 58A can all be part of a remote system 35 having a remote input station 58 having remote input controls 58 (also referred to herein as “remote input 58”), can include a remote display 56, and that can communicate with communication system 54 wirelessly as illustrated or can communicate in a wired fashion. In an alternative embodiment, a local input station including either or both of a local display 66 and local input controls 68 (also referred to herein as “local user input 68”) can be connected to communication system 54 using a wired or wireless connection.

Communication system 54 can include for example, one or more optical, radio frequency or other transducer circuits or other systems that convert image and other data into a form that can be conveyed to a remote device such as remote memory system 52 or remote display 56 using an optical signal, radio frequency signal or other form of signal. Communication system 54 can also be used to receive a digital image and other data from a host or server computer or network (not shown), a remote memory system 52 or a remote input 58. Communication system 54 provides processor 34 with information and instructions from signals received thereby. Typically, communication system 54 will be adapted to communicate with the remote memory system 52 by way of a communication network, such as a conventional telecommunication or data transfer network, such as the internet, a cellular, peer-to-peer or other form of mobile telecommunication network, a local communication network, such as a wired or wireless local area network or any other conventional wired or wireless data transfer system. In one useful preferred embodiment, the electronic system 20 can provide web access services to remotely connected computer systems (e.g. remote systems 35) that access the electronic system 20 through a web browser. Alternatively, remote system 35 can provide web services to electronic system 20 depending on the configurations of the systems.

User input system 26 provides a way for a user of electronic system 20 to select modifications to the proposed photo book provided by electronic system 20. It will be understood that the input system 26 can also be used for a variety of purposes including, but not limited to, permitting a user to arrange, organize and edit images to be incorporated into the photo book.

User input system 26 can include any form of transducer or other device capable of receiving an input from a user and converting this input into a form that can be used by processor 34. For example, user input system 26 can comprise a touch screen input, a touch pad input, a 4-way switch, a 6-way switch, an 8-way switch, a stylus system, a trackball system, a joystick system, a voice recognition system, a gesture recognition system a keyboard, a remote control or other such systems. In the embodiment shown in FIG. 2, user input system 26 includes an optional remote input 58 including a remote keyboard 58a, a remote mouse 58b, and a remote control 58c and a local input controls 68 including a local keyboard 68a and a local mouse 68b.

Remote input 58 can take a variety of forms, including, but not limited to, the remote keyboard 58a, remote mouse 58b or remote control handheld device 58c illustrated in FIG. 2. Similarly, local input 68 can take a variety of forms. In the preferred embodiment of FIG. 2, local display 66 and local user input 68 are shown directly connected to processor 34.

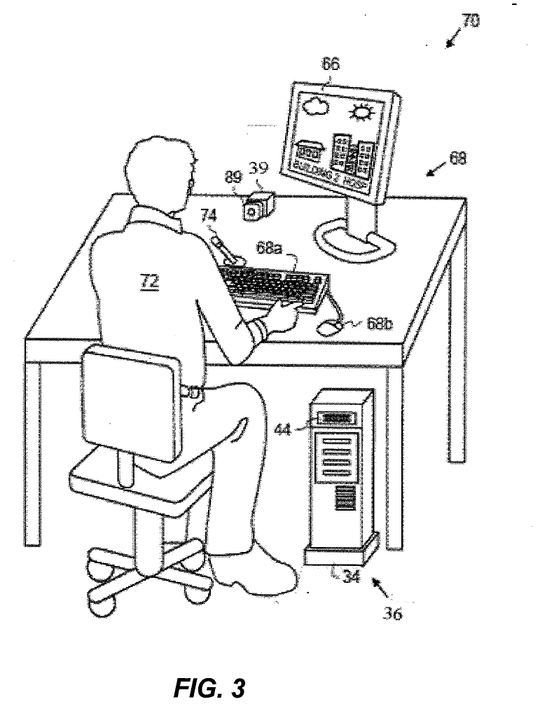

As is illustrated in FIG. 3, local input controls 68 can take the form of a home computer having a processor 34 and disc storage 44, an editing studio, or kiosk 70 (hereafter also referred to as an “editing area 70”) that can also be a remote system 35 or electronic system 20. In this illustration, a user 72 is seated before a console including a local keyboard 68a and mouse 68b and a local display 66 which is capable, for example, of displaying multimedia content. As is also illustrated in FIG. 3, editing area 70 can also have sensors 38 (see FIG. 2) including, but not limited to, a video camera 39 including a lens 89, an audio microphone 74 and other sensors such as multispectral sensors that can monitor a user 72.

Referring back to FIG. 2, output system 28 is used for producing hardcopy output, such as photo books. In this regard, output system 28 can include any conventional structure, system, or output device 32 that is known for printing or recording images, such as printer 29. Printer 29 can record images on a tangible surface 30 using a variety of known technologies including, but not limited to, conventional four-color offset separation printing or other contact printing, silk screening, dry electrophotography such as is used in the NexPress 2100 printer sold by Eastman Kodak Company, Rochester, N.Y., USA, thermal printing technology, drop-on-demand inkjet technology and continuous inkjet technology.

Processor 34 operates electronic system 20 based upon signals from user input system 26, sensors 38, memory section 40 and communication system 54. Processor 34 can include, but is not limited to, a programmable digital computer, a programmable microprocessor, a programmable logic processor, a series of electronic circuits, a series of electronic circuits reduced to the form of an integrated circuit, or a series of discrete components.

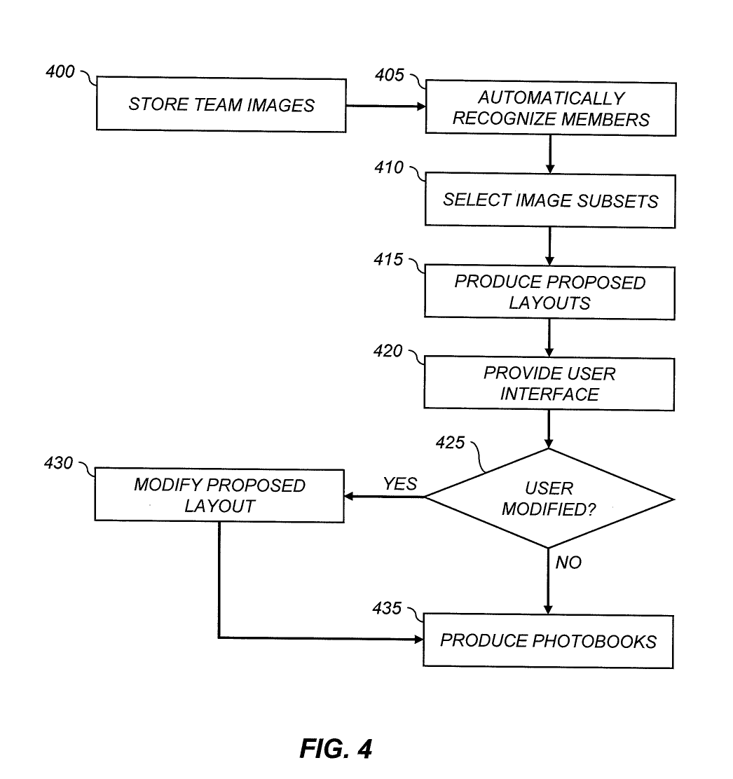

FIG. 4 depicts a high-level flow chart used by the processer in FIG. 1 for producing personalized team photo books. Each photo books is personalized for a particular member of the team by making that member the “star” of their particular photo book.

In store team images step 400, a plurality of images are stored in data storage system 140 of system 100, as described earlier in reference to FIG. 1. The plurality of stored images includes one or more group images of the team members, as well as images which include one or more individual team members participating in different events. For example, if the team is a baseball team, the plurality of stored images can include one or more posed team images, which include all of the team members and can also include the team coach or coaches. The plurality of stored images can also include photos taken at different team events, such as games, practice sessions, and team banquets. The events are identified using metadata stored in association with the stored images. For example, the metadata can be stored as part of the image file which contain the image data, or the metadata can be stored using a separate database along with an identifier that identifies the image that the image is associated with. The metadata can include the date and time that the image was taken, which can be used to identify the event, such as the game.

It will be understood that some of the plurality of stored images will include only a single team member (such as a photo of the pitcher throwing the ball) and some will include several team members (such as multiple infielders involved in a double-play)

In automatically recognize members step 405, the processor in the data processing system 110 automatically recognizes the team members in the plurality of stored images.

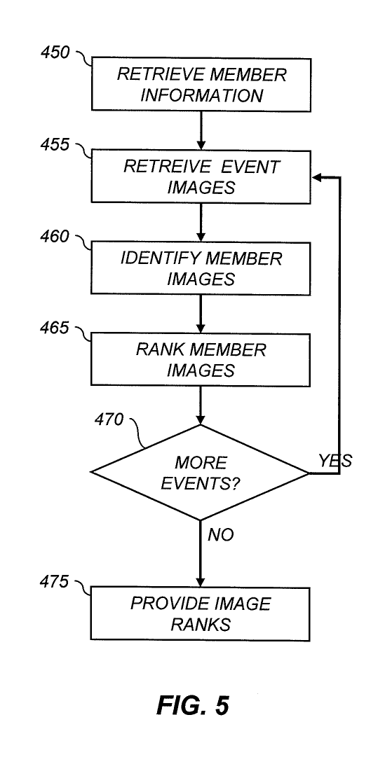

FIG. 5 depicts a more detailed flow chart of one embodiment of step 405 in FIG. 4, which includes the automatic recognition of team members;

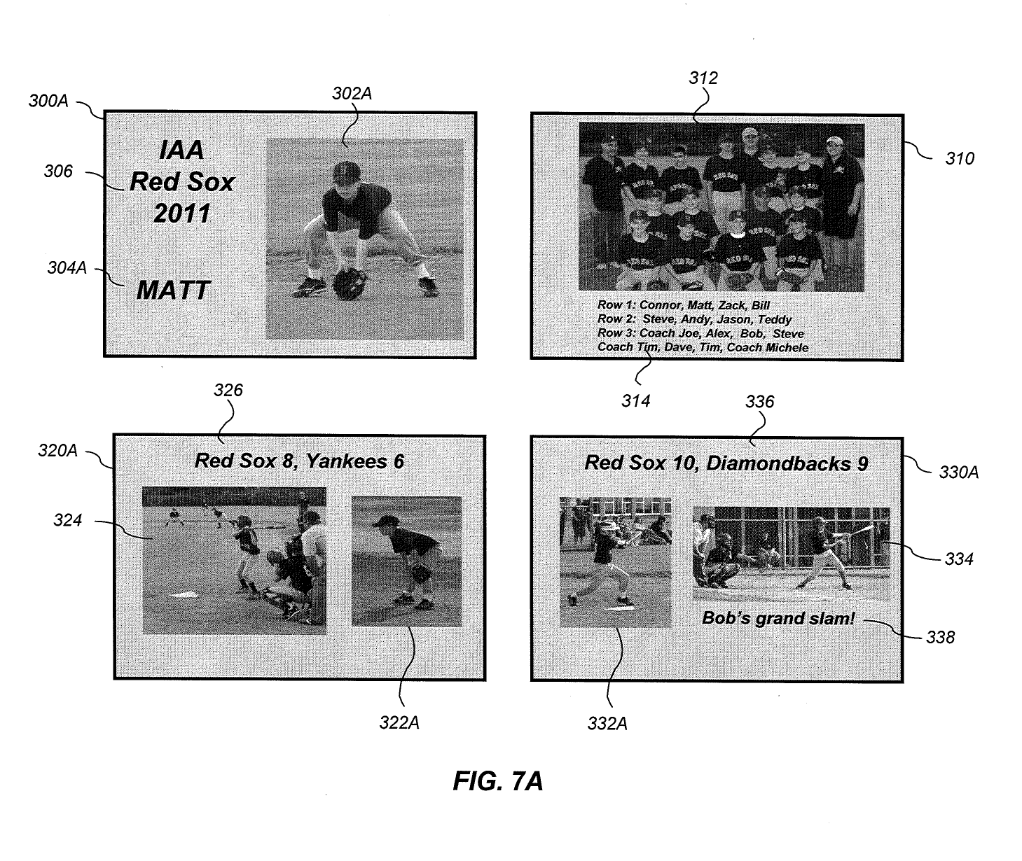

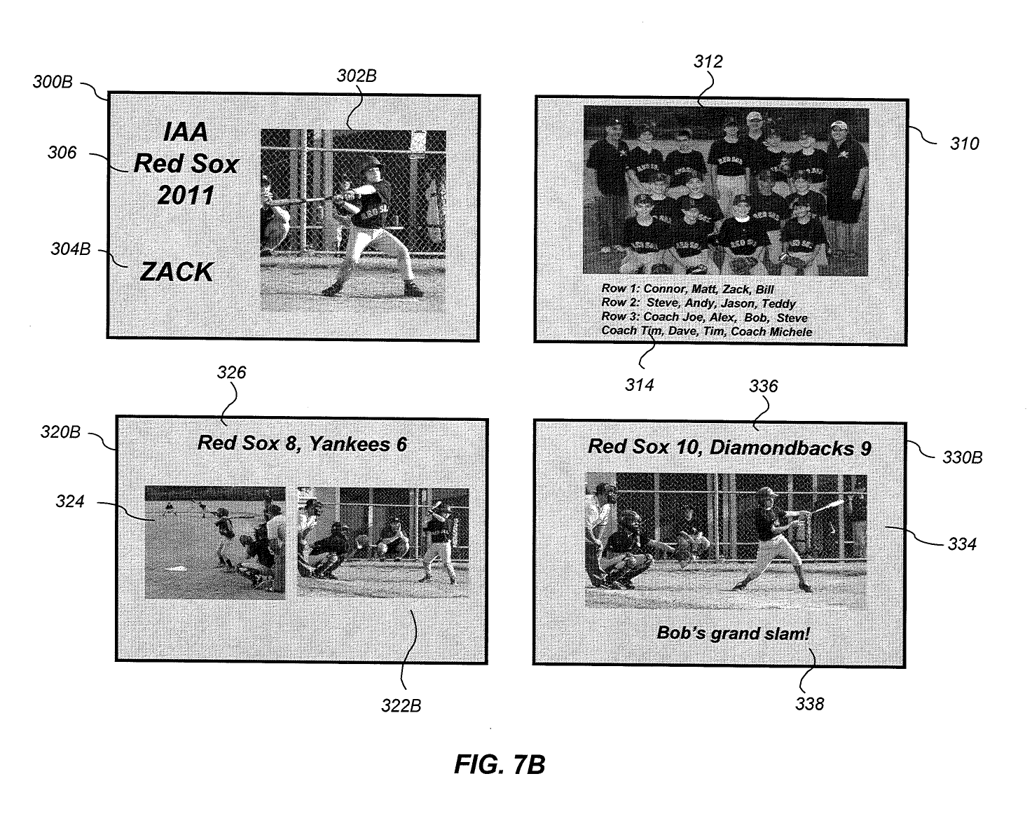

In retrieve member information step 450, team member information is retrieved. In some embodiments, the team member information includes the name, identifier, and facial recognition information for the team members. The identifier can be, for example, the jersey number of the player. In some embodiments, the names and jersey numbers of team members are associated with the faces in the group image of the team by the team manager, as will be described later in reference to FIG. 7A.

In retrieve event images step 455, the images captured during the first event are retrieved, so that images from the event can be selected for use in the personalized photo books. In some embodiments, the images are retrieved by retrieving all of the images captured on the date associated with the first event.

In identify member images step 460, the processor in the data processing system 110 analyzes the pixel data of the images in order to recognize faces of particular team members in the images using a variety of known face recognition algorithms. Such algorithms are described, for example, in a paper titled “W. Zhao, R. Chellappa, A. Rosenfeld, P. J. Phillips, “Face Recognition: A Literature Survey”, ACM Computing Surveys, 2003, pp. 399-458 and is incorporated herein by reference. In some embodiments, the processor in the data processing system 110 also uses different identifiers, such as jersey numbers, worn by different team members to identify particular team members.

In some embodiments, the processor in the data processing system 110 identifies one or more images that include the team coach, so that some of these images can be provided as part of the proposed photo book layout.

In rank member images step 465, the top ranked images of each individual taken during the event are determined. In some embodiments, this determination is done by determining the composition, quality, and resolution. Images in which the member is more prominent would rank higher in preference than images in which the member, though present, is not as prominent. For example, an image in which the member is facing the capture device with a pleasing expression and filling a significant portion of the image would rank higher than an image in which the member is facing away from the capture device and filling a small portion of the image. As another example, an image of the member which is blurry would rank lower than a similar image of the member which is properly focused.

It will be understood that in some embodiments an image can be cropped to improve the ranking if the original image contains sufficient resolution. For example, distracting background can be cropped away, or which includes multiple team members can be cropped to include only one of the team members.

It will be understood that one or more team members might not be identified in any of the images from a particular event. It may be that the team member could not attend the event, or was not photographed during the event. In this situation, the ranking for these one or more team members will indicate that there are no suitable images of the team member taken at this particular event.

In more events test 470, the processor in the data processing system 110 determines if the images from another event have yet to be retrieved and ranked. If there are more events to be analyzed (yes to more events test 470), then the images for the next event are retrieved in retrieve event images step 455. If all of the events have been analyzed (no to more events test 470) then in provide image ranks step 475, the image ranks for each team member, from each event, are provided, so that the top ranked images from each event can be used in the personalized photo book for each team member.

Returning to FIG. 4, in select image subsets step 410, the processor in the data processing system 110 automatically selects a subset of the plurality of stored images for particular members of the team including images associated with at least two different events. This selection is done using the image ranks described earlier in reference to FIG. 5. In some embodiments, the image subset can include the same number of images per team member (e.g. one or two images per team member) per event. In some embodiments, the image subset can include a variable number of highly ranked images per team member, so that a team member with several highly ranked images for a particular event will be featured in more images for the photo book page(s) depicting that particular event, compared to other team members who have a smaller number of highly ranked images.

In produce proposed layouts step 415 of FIG. 4, the processor in the data processing system 110 produces proposed photo book layouts which have been personalized for each team members. As will be described in reference to FIG. 7 A-B, in some embodiments each of the layouts includes at least one group image of the team members and other images depicting the team member in at least two different events. The layout of each of the proposed photo books is organized to differentiate between the different events.

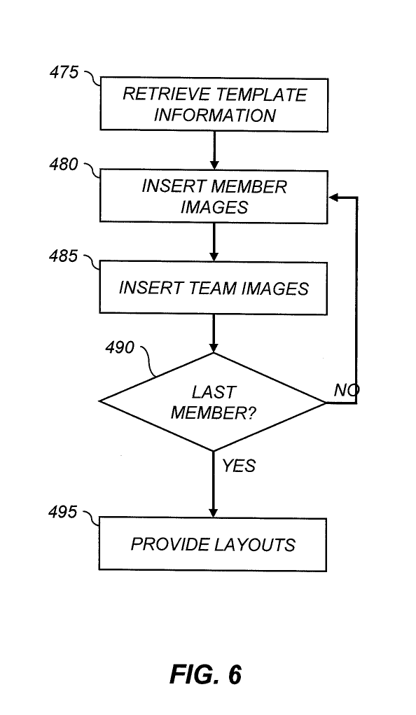

FIG. 7A depicts an embodiment of a first personalized photo book for a first team member named Matt, and FIG. 7B depicts an embodiment of a second personalized photo book for a second team member named Zack. FIG. 7A includes a first page 300A, a second page 310, a third page 320A, and a fourth page 330A. FIG. 7B also includes a first page 300B, a second page 310, a third page 320B, and a fourth page 330B. In FIG. 7A, the first page 300A of the first photo book is a cover page, and includes a cover caption 306 “IAA Red Sox 2011” which provides the league name “IAA”, the team name “Red Sox”, and the year “2011”. In some embodiments, this cover caption is entered by the team manager and stored in the template used to create the photo book as described earlier in reference to step 475 of FIG. 6. The first page 300A of the first photo book also includes the image 302A and the name 304A of the particular player “Matt” who is the “star” of the first photo book.

In FIG. 7B, the first page 300B of the second photo book is a cover page, and includes the same cover caption 306 “IAA Red Sox 2011” as the first page 300A of the first photo book shown in FIG. 7A. The first page 300B of the second photo book also includes the image 302B and the name 304B of the particular player “Zack” who is the “star” of the second photo book.

The second page 310 of both the first personalized photo book depicted in FIG. 7A and the second personalized photo book depicted in FIG. 7B includes the same group image of the team members 312 and a caption 314 listing the members of the team. In some embodiments, the group image of the team members 312 and the team members names used in caption 314 is entered by the team manager when the template used for the photo book is created, in order to identify each team member. In some embodiments, the team manager can also enter a jersey number for each team members. Each team members name is then associated with a particular face and a particular jersey number. The team member's face and jersey number is used to identify the particular team member in images captured during team events.

Returning to FIG. 7A, the third page 320A of the first photo book depicts a first event, which is a baseball game where the Red Sox played the Yankees. The third page 320A of the first photo book includes an event caption 326 “Red Sox 8, Yankees 6” which provides final score of this particular baseball game event. In some embodiments, this event caption is entered by the team manager and stored in the template used to create the photo book as described earlier in reference to step 475 of FIG. 6. The third page 320A of the first photo book also includes an image 322A of the particular player “Matt” taken at the first event depicted on page 320A. The image 322A is automatically included as the team member image on the third page 320A since it was the top ranked image of the team member “Matt” at this event, as described earlier in reference to step 465 of FIG. 5. The third page 320A of the first photo book also includes an image 324 which depicts an important aspect of the first event, such as a photo of another team member getting the game-winning hit. In some embodiments, image 324 is selected by the team manager and stored in the template used to create the photo book as described earlier in reference to step 475 of FIG. 6.

Turning to FIG. 7B, the third page 320B of the second photo book also depicts a first event, and includes the same event caption 326 “Red Sox 8, Yankees 6” which provides final score of this particular baseball game event. The third page 320B of the second photo book also includes an image 322B of the particular player “Zack” taken at the first event depicted on page 320B. The third page 320B of the second photo book also includes the image 324 of the game winning hit by a team member, which was also used on the third page 320A of the first photo book.

Returning to FIG. 7A, the fourth page 330A of the first photo book depicts a second event, which is a baseball game where the Red Sox played the Diamondbacks. The fourth page 330A of the first photo book includes an event caption 336 “Red Sox 10, Diamondbacks 9” which provides final score of this particular baseball game event. The fourth page 330A of the first photo book also includes an image 332A of the particular player “Matt” taken at the second event depicted on the fourth page 330A. The fourth page 330A of the first photo book also includes an image 334 which depicts an important aspect of the second event, which is a grand slam hit by Bob, and described in image caption 338 “Bob's grand slam”.

Turning to FIG. 7B, the fourth page 330B of the second photo book also depicts the second event, and includes the same event caption 336 “Red Sox 10, Diamondbacks 9” which provides final score of this particular baseball game event. The fourth page 330B of the second photo book does not include an image of “Zack”, since no images of Zack were taken at the second event. Instead, the image 324 of the game winning hit by the team member is enlarged to better fill the page. In some embodiments, the fourth page 330B of the second photo book is deleted from the second photo book, since no images of Zack at the second event were identified in identify member images step 460 of FIG. 5.

While the photo books shown in FIG. 7A and FIG. 7B include only four pages, it will be understood that personalized photo books can include many more pages, and many more images.

FIG. 6 depicts a more detailed flow chart of step 410 in FIG. 4 depicting the process of producing proposed layouts, such as the proposed layouts depicted in FIG. 7A-B.

In retrieve template information step 475, template information is retrieved from data storage system 140. The template information defines characteristics of the proposed photo book layouts. In some embodiments, the template information includes the size, style, and background color of the proposed photo book. In some embodiments, the template information is automatically provided by the system 100. In some embodiments, the template information is created by an individual associated with the team, such as the team manager. In some embodiments, the team manager selects the cover color and background color of the proposed photo book layout to correspond to the team colors. In some embodiments, the team manager enters event names and associated information (such as the opponents and scores of individual games shown in event caption 326 and event caption 336 in FIG. 7A and FIG. 7B) which are stored as event metadata as part of the template information. In some embodiments, the team manager identifies the locations in the proposed layout where particular team images (such as the team's group image 310 shown in FIG. 7A and FIG. 7B) and highlight images (for example images of key plays during each event, such as image 324 and image 334 in FIG. 7A and FIG. 7B) will be placed. In some embodiments, the team manager enters captions and other information associated with the highlight images (such a image caption 338 in FIG. 7A and FIG. 7B).

In insert member images step 480 of FIG. 6, the system 100 inserts the highest ranked images of a particular team member captured during a particular event into the appropriate template locations of the proposed photo book for each particular event. It will be understood that in some situations, there will be no images of the particular team member for a particular event, as described earlier in reference to FIG. 5. For example, the team member might not have attended that particular event due to a scheduling conflict, or may have not been photographed during the time they participated in the particular event.

In insert team images step 485, the system 100 inserts team images, including at least one group image of the team members, into the pages of the proposed photo book for each particular event. In some embodiments, if there are no images of the particular team member available for a particular event, a highlight image is enlarged to cover the space which would otherwise be filled with an image of the particular team member. In some embodiments, if there are no images of the particular team member available for a particular event, an alternate image is used for the template location that would otherwise include an image of the particular team member. In some embodiments, if there are no images of the particular team member available for a particular event, that particular event is removed from the proposed photo book layout for that particular team member.

In last member test 490, the system 100 determines whether the insert member images step 480 and the insert team images step 485 have been completed for all of the team members If not (no to last member test 490), the insert member images step 480 and the insert team images step 485 are repeated for the additional team members.

In provide layouts step 495, the system 100 produces proposed photo book layouts which are personalized for each of the team members. Each of the layouts includes one or more group images of the team members as well as images depicting the team member in a number of different events. In some embodiments, the layout of the proposed photo book is organized to differentiate between the various events.

Returning to FIG. 4, in provide user interface step 420, the system 100 provides to two or more users for use on a display, a user interface that enables each user to review a particular personalized proposed photo book, and select modifications to the proposed photo book. It will be understood that the users who review the personalized proposed photo books are associated with particular team members. For example, in some situations the user associated with a particular team member can be the team member's mother, father, or guardian. In some situations, the user associated with a particular team member can be the actual team member.

In some embodiments, the system 100 uses password protected login accounts to ensure that only the user associated with a particular team member can access the proposed photo book layout for the particular team member. In some embodiments, the user associated with a particular team member is permitted to authorize others to access the proposed photo book layout for the particular team member.

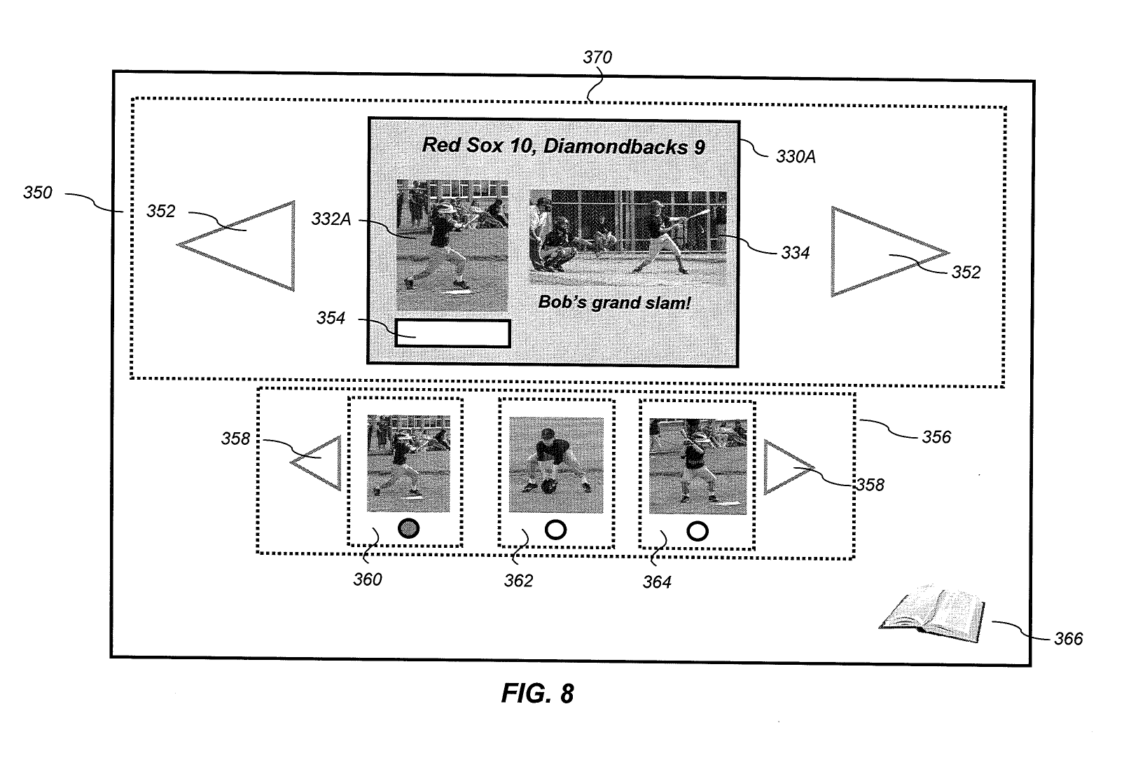

FIG. 8 depicts a user interface 350 for enabling users to review proposed photo books. As described earlier in reference to FIG. 1-3, it will be understood that the user interface 350 is displayed on a display screen, and that the user can select icons included within the user interface 350 using various types of user controls, for example a touch screen, mouse, keyboard, or voice recognition. The user interface 350 includes a page layout section 370 which displays one of the pages of the proposed photo book layout for a particular team member, such as the fourth page 330A of the first photo book described earlier in reference to FIG. 7A. The page layout section 370 also includes arrow icons 352 to permit the user to select the next page, or the previous page, of the proposed photo book layout. The page layout section 370 also includes a team member caption window 354. The user can type a caption in team member caption window 354 in order to annotate the image of the particular team member, thereby modifying the proposed photo book layout.

The user interface 350 also includes an alternate image selection window 356 which permits the user to modify the proposed photo book by changing the team member image. In the example shown in FIG. 8, the team member image 332A in the proposed photo book page 330A can be changed by the user by selecting one of the alternate images shown in selection box 362 or selection box 364, rather than the proposed team member image shown in selection box 360. For example, by selecting the radio button shown in selection box 362, the user can replace the picture of Matt at bat (which may be the highest ranked image of Matt at this event) with the picture of Matt fielding the baseball (which may be the second highest ranked image of Matt at this event). The alternate image selection window also includes arrows 358 which permit other images of the team member taken at the event to be displayed, in place of some of the images in selection boxes 360, 362, and 364.

In some embodiments, the user is permitted to replace the single team member image 332A in the proposed photo book layout 330A with multiple images. For example, the user can select both the radio button in selection box 360 and the radio button in selection box 362 in order to modify the proposed photo book layout to include both of the associated images in the photo book page for this event. In this example, the size of image 334 would be reduced, in order to provide more space on the page for the two team member images.

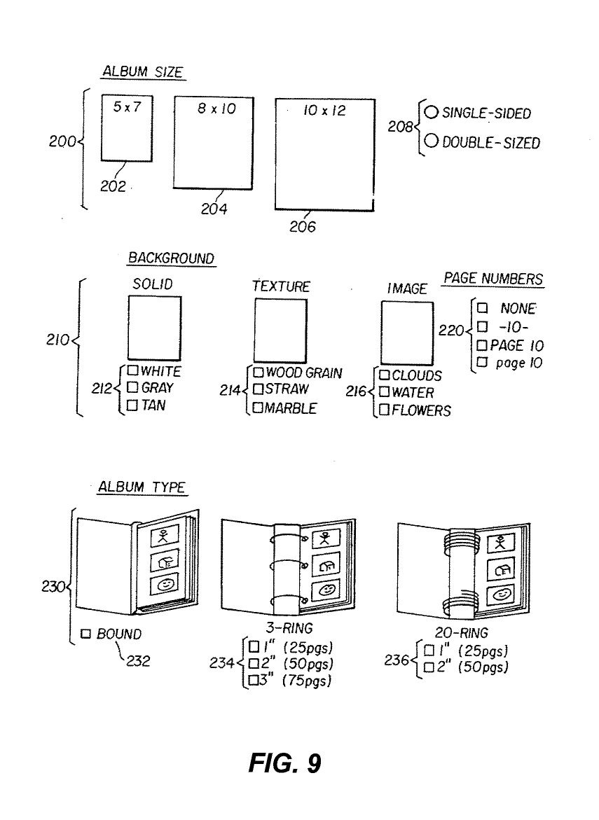

The user interface 350 also includes a photo book type icon 366, which permits the user to select a photo book type from a plurality of photo book types, as will be described in reference to FIG. 9.

FIG. 9 depicts different types of personalized photo books which can be selected by the users of system 100, so that different team members can purchase different types of personalized team photo books. The different types of photo books include different styles and sizes of photo books that can be selected by the users. The options include selecting the size of the album from a plurality of sizes 200, including 5″×7″ size 202, 8″×10″ size 204, and 10″×12″ size 206. The user selects the size by selecting the appropriate print size icon (e.g. icon 202, 204, or 206). The options also include using radio buttons 208 to select single-sided pages (e.g. print only on 1 side of the album page) or double-sided pages. The options further include selecting a preferred background style from a plurality of styles 210, including solid backgrounds 212 in white, gray, or tan, textured backgrounds 214 in wood grain, straw, or marble, and background images 216 including clouds, water, or flowers. The user selects the background style by selecting the appropriate radio button (e.g. one of buttons 212, 214, or 216). The user then selects whether to include a page number from a plurality of options using radio buttons 220. The options include no page numbers and several different styles of page numbers. The color, size, and font of the text used for the page numbers and image captions can also be selected using a separate menu (not shown). Finally, the user selects an album type from a plurality of album types 230. The album type is selected by the user by selecting one of the radio buttons for bound albums 232, 3-ring albums 234 or 20-ring albums 236. Of course, many more size, background, and album type options can be presented to the user using various types of displays, such as pull-down menus, radio buttons, and scroll bars. The selected combination of album size, background, page numbers, and album type is then presented to the user. For example, if the user selects an 8″×10″ double-sided album pages in a 3-ring, 2″ thick binder with a marble texture background and a particular page number style, the system 100 presents to the user a proposed personalized photo book depicting this combination for the user to review.

Returning to FIG. 4, in user modified test step 425, the system 100 determines if any modifications to a particular proposed photo book layout were selected by the user.

If the user associated with the particular team has modified the proposed photo book layout (yes to user modified test 425), then in modify proposed layout step 430, the system 100 modifies the proposed layout of a particular personalized photo book in response to input from the user associated with the particular team member. In some embodiments, modified proposed layouts can be displayed to the user, using the user interface described earlier in reference to FIG. 4, immediately after each modification has been selected by the user.

In produce photo books step 435, the system 100 produces the plurality of personalized photo books responsive to the modifications selected by each of the users associated with each of the team members. The personalized photo books can be printed using the printers described earlier in reference to FIG. 2.

In some embodiments, personalized photo books for some team members can be printed using an on-line photo service provider. The photo service provider can uses a payment identifier, such as an account number or a credit card number, to obtain payment from the user. The photo service provider can ship the photo book to the team member, for example as described in U.S. Pat. No. 6,915,273 to Parulski, entitled “Method for providing customized photo products over a network using images captured from a digital camera”, which is incorporated herein by reference.

The invention has been described in detail with particular reference to certain preferred embodiments thereof, but it will be understood that variations and modifications can be effected within the spirit and scope of the invention.

### PARTS LIST

9, 18 Number of Images
20 electronic system
22 housing
24 source of digital images
26 user input system
27 graphic user interface
28 output system
29 printer
30 tangible surface
32 output device
34 processor
35 remote system
38 sensors
39 video camera
40 memory section
42 hard drive
44 disk drive
46 memory card slot
48 removable memory
50 memory interface
52 remote memory system
54 communication system
56 remote display
58 remote input
58a remote keyboard
58b remote mouse
58c remote control
66 local display
68 local input controls
68a local keyboard
68b local mouse
70 home computer, editing studio, or kiosk (“editing area”)
72 user
74 microphone
89 camera lens
100 system
110 data processing system
120 peripheral system
130 user interface system
140 data storage system
200 plurality of sizes
202 print size icon
204 print size icon
206 print size icon
208 radio buttons
210 plurality of styles
212 solid background style
214 textured backgrounds
216 background images
220 radio button
230 plurality of album types
232 bound albums
234 3-ring albums
236 20-ring albums
300A first page
300B first page
302A image
302B image
304A name
304B name
306 cover caption
310 second page
312 group image
314 caption
320A third page
320B third page
322A image
322B image
324 image
326 event caption
330A fourth page
330B fourth page
332A image
334 image
336 event caption
338 image caption
350 user interface
352 arrow icons
354 team member caption window
356 alternate image selection window
358 arrows
360 selection box
362 selection box
364 selection box
366 photo book type icon
370 page layout section
400 store team images step
405 automatically recognize members step
410 select image subsets step
415 produce proposed layouts step
420 provide user interface step
425 user modified? decision step
430 modify proposed layout step
435 produce photo books step
450 retrieve member information step
455 retrieve event images step
460 identify member images step
465 rank member images step
470 more events? decision step
475 retrieve template information step
280 insert member images step
485 insert team images step
490 last member? decision step
495 provide layouts step

1. A method for use in producing a plurality of personalized photo books for members of a team, comprising:
a) storing a plurality of images including at least one group image of the team members and images including individual team members participating in different events;
b) using a processor to:
i) automatically recognize the team members in the plurality of stored images; and
ii) select a subset of the plurality of stored images for particular members of the team including images associated with at least two different events;
c) producing a plurality of proposed photo book layouts personalized for each of a plurality of team members and further including in the layout the at least one group image of the team members and other images depicting the team member in at least two different events, wherein the layout is organized to differentiate between the at least two different events;
d) providing to two or more users for use on a display, a user interface that enables each user to review a particular personalized proposed photo book, and select modifications to the proposed photo book; and
e) producing the plurality of personalized photo books responsive to the modifications selected by each of the two or more users.

2. The method according to claim 1 further including printing the personalized photo books.

3. The method according to claim 2 wherein each of the proposed photo book layouts uses a common template and includes predetermined image compositions.

4. The method according to claim 1 wherein the proposed photo book layouts include team scores associated with the at least two different events.

5. The method according to claim 1 wherein the proposed photo book layouts include individual images of each team member.

6. The method according to claim 5 further including identifying an image that includes the team coach and providing that image in the proposed photo book layout.

7. The method according to claim 1 further including different identifiers worn by different team members to identify particular team members.

8. The method according to claim 1 wherein the user interface enables users to select a photo book size from a plurality of sizes.

9. The method according to claim 1 wherein the user interface enables users to select a photo book style from a plurality of styles.

10. The method according to claim 1 further including storing a template which defines locations for placing images of team members in the layouts for the at least two different events, and using the template to produce the plurality of proposed photo book layouts.

11. The method according to claim 10 wherein if there are no images of the particular team member associated with a particular event, using an alternate team image is used for location that would otherwise include an image of the particular team member.

12. The method according to claim 10 wherein if there are no images of the particular team member associated with a particular event, removing that particular event from the proposed photo book layout for that particular team member.
